(19) United States
(12) Patent Application Publication
(10) Pub. No.: US 2010/0228843 A1
(43) Pub. Date: Sep. 9, 2010

(54) ELEMENT MANAGEMENT SYSTEM IN WIRELESS COMMUNICATION NETWORK

(75) Inventors: Jung-Hyun Ok, Seoul (KR); Se-Whan Ko, Seongnam (KR); Keun-Ryol Park, Seongnam (KR)

Correspondence Address: AMPACC Law Group, 3500 188th Street S.W., Suite 103, Lynnwood, WA, 98037, US

(73) Assignee: Posdata Co. ltd, Kyeonggi-do (KR)

(21) Appl. No.: 12/377,383

(22) PCT Filed: Aug. 16, 2007
(86) PCT No.: PCT/KR2007/003922

§ 371 Date: Feb. 12, 2009

(30) Foreign Application Priority Data
Aug. 16, 2006 (KR) 1020060077217

(51) Int. Cl. G06F 15/173

(52) U.S. Cl. 709/223

(57) ABSTRACT

Disclosed are an element management system and a method thereof that efficiently manage network elements of a wireless communication network, such as an RAS and an ACR. According to the present invention, it is possible to efficiently manage an RAS and an ACR so as to provide a stable wireless communication service, by implementing an element management system for managing network elements of a wireless communication network. Further, it is possible to implement an EMS server, which has a modularized construction including modules, which correspond to functions of the EMS and are arranged in a physically separated manner, so as to facilitate future addition and change of functions of the EMS. Moreover, it is possible to reduce loads on an EMS server by efficiently implementing information transmission and control paths of an EMS server and an EMS client.

### TECHNICAL FIELD

The present invention relates to an element management system of a wireless communication network, and more particularly to a system for efficiently managing elements of a wireless communication network, such as an RAS and an ACR.

### BACKGROUND ART

With the recent development of electronic/communication technology, a variety of communication services have been provided using a wireless communication network, such as mobile communication, a portable internet, etc. As shown in FIG. 1, a wireless communication network includes network elements such as a Portable Subscriber Station (PSS), a Radio Access Station (RAS), and an Access Control Router (ACR). Herein, the PSS communicates with the RAS through a wireless communication channel, so that the PSS can use a variety of communication services provided from the ACR interworking with the RAS.

The detailed function of these elements will be described taking an example of a case where a wireless communication network provides a portable internet service. A PSS performs various functions including a portable internet wireless connection function, an IP based service connection function, an IP mobility function, a terminal/user authentication and security function, a multicast service reception function, an interworking function with another network, etc. Herein, the RAS performs various functions including a portable internet wireless connection function, a wireless resource management and control function, a mobility (handoff) support function, an authentication and security function, a Quality of Service (QoS) management function, a downlink multicast function, a billing and statistics generation function, a reporting function, etc. Herein, the ACR performs various functions including an IP routing and mobility management function, an authentication and security function, a QoS management function, a billing service provision function, a mobility control function between RASs within ACRs, a resource management and control function, etc.

Meanwhile, it is necessary to manage network elements, such as an ACR and an RAS in order to stably provide a portable internet service. For example, the portable internet service requires an element management system which can effectively perform various functions including managements of configuration, fault, status, security, download, statistics, diagnostics & test, performance, etc.

### DISCLOSURE OF INVENTION

### Technical Problem

Therefore, the present invention has been made in view of the above-mentioned problems, and the present invention provides an Element Management System (EMS) of a wireless communication network effectively managing network elements, such as an RAS and an ACR so as to provide a wireless communication service.

In addition, the present invention provides an EMS server having a modularized construction including modules, which correspond to functions of the EMS and are arranged in a physically separated manner, so as to facilitate future addition and change of functions of the EMS server.

Furthermore, the present invention provides an element management system which efficiently implements command transmission and a control path of an EMS server and an EMS client, thereby reducing the load on the EMS server.

### Technical Solution

In accordance with an aspect of the present invention, there is provided a system for managing elements of a wireless communication network, the system including: an EMS client including a graphic user interface unit for matching with an operator, a command management unit for receiving a command from the graphic user interface unit and transmitting the received command to a socket handler, and the socket handler for transmitting the command transmitted from the command management unit to an EMS server; and the EMS server including a system front-end function unit for matching with the EMS client, an element interface unit for matching with elements of the wireless communication network, and a system back-end function unit for processing the command transmitted from the system front-end function unit and performing at least one of a configuration management function, a fault management function, a download management function, a diagnostics & test management function, a statistics management function, and a performance management function regarding elements of the wireless communication network.

In accordance with another aspect of the present invention, there is provided a server for managing elements of a wireless communication network, the system including: a system front-end function unit for matching with an EMS client, the system front-end function unit having a GUI adaptor connected with the EMS client; a system back-end function unit for responding to a command received from the EMS client, and performing at least one of a configuration management function, a fault management function, a download management function, and a diagnostics & test management function regarding elements; and an element interface unit for transmitting a command to the elements of the wireless communication network, and receiving a massage and data necessary for execution of the functions from the elements.

Desirably, the EMS server further comprises an NMS interface unit for matching with the NMS, and the NMS interface unit include an EMS agent interworking with an EMS manager of the NMS in the wireless communication network.

### ADVANTAGEOUS EFFECTS

According to the present invention, it is possible to efficiently manage an RAS and an ACR so as to provide a stable wireless communication service, by implementing an element management system for managing network elements of a wireless communication network.

Further, according to the present invention, it is possible to implement an EMS server, which has a modularized construction including modules, which correspond to functions of the EMS and are arranged in a physically separated manner, so as to facilitate future addition and change of functions of the EMS server.

Moreover, according to the present invention, it is possible to reduce loads on an EMS server by efficiently implementing information transmission and control paths of an EMS server and an EMS client.

### BRIEF DESCRIPTION OF THE DRAWINGS

The foregoing and other objects, features and advantages of the present invention will become more apparent from the following detailed description when taken in conjunction with the accompanying drawings in which:

FIG. 1 shows an example of a hierarchical structure of a wireless communication network according to the present invention;

FIG. 2 shows an interworking relation between an element management system and other system;

FIG. 3 shows a detailed block diagram of an EMS server according to one embodiment of the present invention;

FIG. 4 is a flowchart showing a process by which an EMS server handles a command for element management according to the present invention;

FIG. 5 shows a detailed block diagram of an EMS client according to one embodiment of the present invention; and

FIG. 6 shows an example of an internal interface of an EMS server according to the present invention.

### MODE FOR THE INVENTION

Hereinafter, an exemplary embodiment of the present invention will be described in detail with reference to the accompanying drawings. Well known functions and constructions are not described in detail since they would obscure the invention in unnecessary detail.

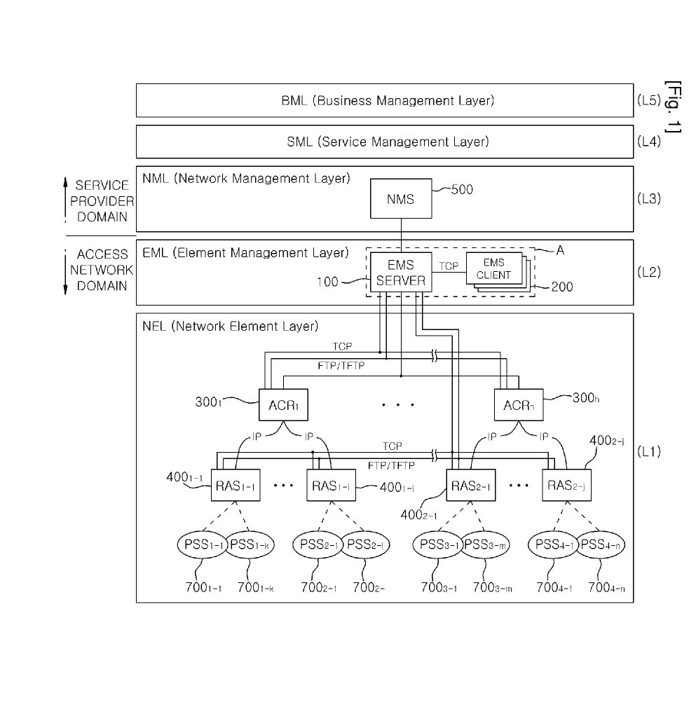

Hereinafter, the hierarchical structure of the wireless communication network according to the present invention will be described with reference to FIG. 1. The wireless communication network may be classified into an access network domain for operation environment setting of network elements, wired/wireless resource management, status checking, etc., and a service provider domain for mobile communication/portable internet service provision, subscriber management, etc. Herein, the access network domain includes a Network Element Layer (NEL) (L1) and an Element Management Layer (EML) (L2), and the service provider domain includes a Network Management Layer (NML) (L3), a Service Management Layer (SML) (L4), and a Business Management Layer (BML) (L5).

At the NEL (L1), network elements, such as a PSS 700, an RAS 400, an ACR 300, etc., are placed. At the EML (L2), an Element Management System (EMS) server 100 managing the PSS, the RAS, the ACR, etc., and an EMS client 200 are placed.

Meanwhile, the EMS server 100 is connected with a Network Management System (NMS) 500 placed at the NML (L3), and the EMS server 100 enables a service provider to manage network elements through the NMS.

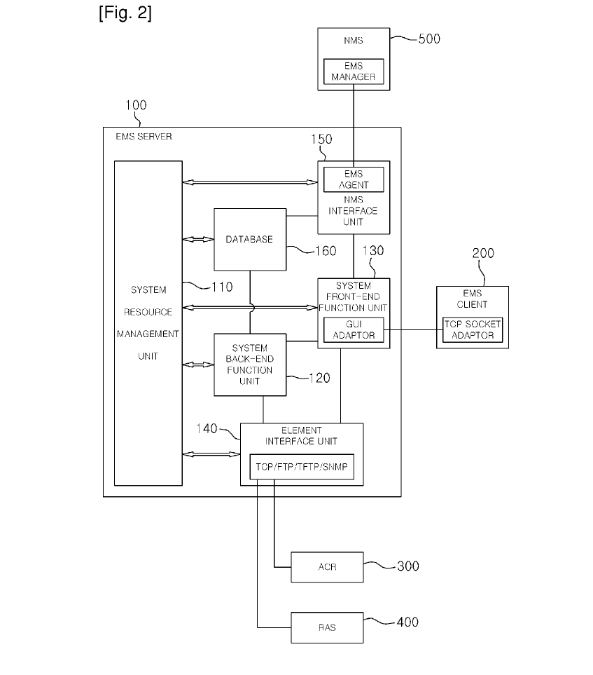

FIG. 2 shows an interworking relation between an element management system and other system.

The element management system according to the present invention includes the EMS server 100 and the EMS client 200. Herein, the EMS server 100 directly interworks with the ACR 300 and the RAS 400 (i.e. network elements) and manages them, and the EMS client 200 provides a user interface which enables an operator to synthetically monitor and control the ACR 300 and the RAS 400 through the EMS server.

Hereinafter, the EMS server 100 will be described with reference to FIG. 2. The EMS server according to the present invention includes a system resource management unit 110, a system back-end function unit 120, a system front-end function unit 130, an element interface unit 140, an NMS interface unit 150, and a database (DB) 160.

The system resource management unit 110 interworks with the system back-end function unit, the system front-end function unit, the element interface unit, the NMS interface unit, and the database, and the system resource management unit performs various functions including system initialization, system resource management, system maintenance/repair, etc. Specifically, the system resource management unit 110 gathers and monitors data about a CPU load rate, a memory usage rate, a file system usage rate, a network utilization rate, etc, according to a period or the need of an operator, and generally manages the EMS server. Moreover, the system resource management unit 110 manages the database by gathering a database usage status employed in the EMS server, and performs functions associated with all application processes of the EMS server, which include state monitoring, operation interruption, and re-operation. Further, the system resource management unit 110 transmits alarm generation information to the EMS client either if a processor unexpectedly goes down or if various usage rates exceed a predetermined threshold. In contrast, if such usage rates go down below the predetermined threshold, the system resource management unit 110 transmits alarm release information to the EMS client. In this way, the system resource management unit 110 reports the status information to the operator.

The system back-end function unit 120 performs a command control function for processing and various functions related to network elements such as the RAS and the ACR, which include functions of configuration management, fault management, download management, diagnostics & test management, statistics management, performance management, etc.

The system front-end function unit 130 interworks with the EMS client and performs a function for matching with an operator or a function for managing a log. As shown in FIG. 2, the system front-end function unit includes a Graphical User Interface (GUI) adaptor connected with a TCP socket adaptor of the EMS client 200, through which a command is received from the EMS client or an event from the elements is transmitted to the EMS client.

The element interface unit 140 matches with network elements, such as the RAS and the ACR. For example, the element interface unit transmits and receives a message and data between the RAS and the ACR according to the Transmission Control Protocol (TCP), the Simple Network Management Protocol (SNMP), the File Transfer Protocol (FTP)/ Trivial FTP (TFTP), etc.

The NMS interface unit 150 matches with the NMS, which is an upper system of the EMS server. To this end, the NMS interface unit includes an EMS agent and the NMS manages an EMS server through an EMS manager connected with the EMS agent. It is preferred that communication is performed between the EMS manager and the EMS agent according to the Simple Object Access Protocol (SOAP). Also, the NMS interface unit may include an Operation Support System (OSS) interface for interworking with an OSS of a service provider. The OSS interface is constructed to be separable from the NMS interface. In a case of actually implementing the OSS interface, the OSS interface can be selectively employed according to whether or not a service provider has the OSS.

The database 160 interworks with the system resource management unit and the system back-end function unit, and stores information related to each element (e.g. RAS, ACR, etc.) managed by the EMS server, which includes package information, configuration information, fault information, statistics information, and history information.

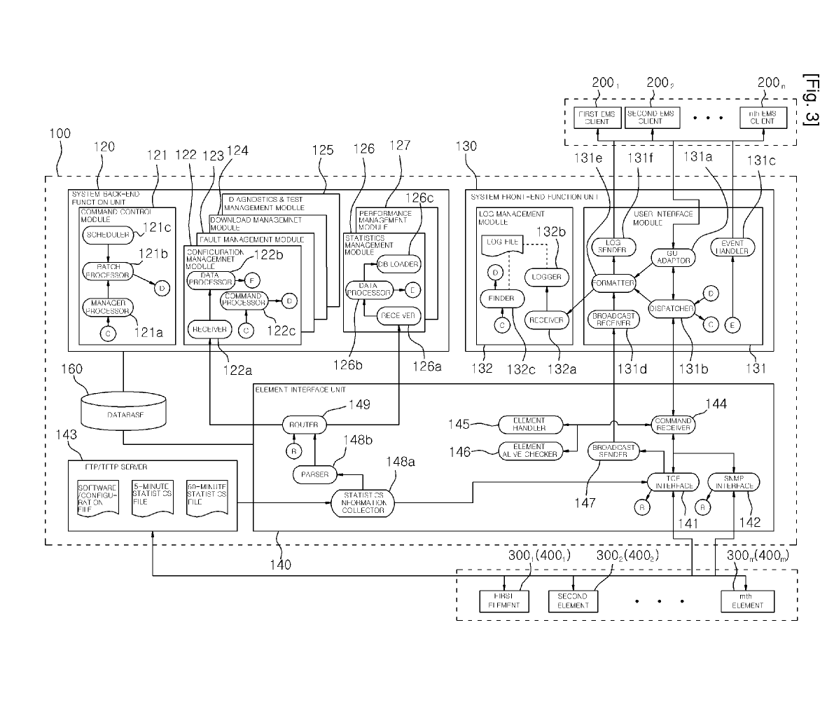

FIG. 3 shows a detailed block diagram of an EMS server according to one embodiment of the present invention. Hereinafter, the EMS server according to the present invention will be described in more detail with reference to FIG. 3. For reference, in order to avoid the complexity of the drawing, FIG. 3 mainly illustrates matters concerned with an EMS client and network elements and does not illustrate a system resource management unit and a Network Management System (NMS) interface unit.

For convenience, the system front-end function unit 130 will be first described. The system front-end function unit according to the present embodiment includes a user interface module 131 for matching with an operator and a log management module 132 for managing a log.

A user interface module 131 receives an operator command from the EMS client and transmits the received command either to the system back-end function unit or to an element interface unit. The user interface module receives a response to the command and transmits the received response to a corresponding EMS client. Further, the user interface module receives an event transmitted in real-time from the network element and transmits the event to the EMS client. To this end, a user interface module includes a GUI adaptor 131a, a dispatcher 131b, an event handler 131c, a broadcast receiver 131d, a formatter 131e, and a log sender 131f.

When a new EMS client accesses the EMS server over the TCP, the GUI adaptor 131a checks if the new EMS client has an accessible IP address, if the new EMS client is within the range of accessible IP addresses, or if the new EMS client is beyond the number of allowable concurrent users, and then allows the new EMS client to access the EMS server. The GUI adaptor 131a removes session information regarding a corresponding EMS client when the EMS client is normally or abnormally terminated. Moreover, the GUI adaptor 131a transmits an operator command, transmitted from the EMS client, to the dispatcher and transmits the command to a formatter so as to output a log or a screen of an input format formulated when necessary. Meanwhile, the GUI adaptor 131a receives the response to the operator command from the network element through the dispatcher and transmits the response to the EMS client.

The dispatcher 131b, which is connected with the GUI adaptor, classifies the command received from the EMS client through the GUI adaptor and transmits the classified command either to the system back-end function unit or to the element interface unit. The dispatcher 131b receives a response to the operator command and transmits the response to the EMS client through the GUI adaptor. Specifically, when a command received from the EMS client corresponds to a simple processing command related to one element, the dispatcher transmits the command to a command receiver of the element interface unit. When the command relates to a number of elements such as adjacent cell registration or when the command corresponds to a complex processing command such as a batch command execution to be processed by reading various commands pre-registered in a database, the dispatcher transmits a response to a command to a command control module of the system back-end function unit. For reference, the simple processing command used in the present invention refers to a command requiring no operation of the system back-end function unit (e.g. monitoring/modification commands of the element status, monitoring/modification commands of the element parameter, other monitoring commands, etc). Such a simple processing command is directly transmitted from a user interface module to an element interface unit, so that it is possible to reduce a load on a server. In contrast, such a complex processing command refers to a command requiring an operation of one or more function modules of the system back-end function unit so as to execute an operator command.

The event handler 131c receives an event, which is generated in a system, from the data processor of a fault management module within the system back-end function unit, and transmits the received event to the EMS client. The event handler 131c also receives a QoS alarm message, generated when a performance threshold set by an operator is exceeded, from a statistics management module and a performance management module, and the event handler transmits the received message to the EMS client. Meanwhile, the broadcast receiver 131d receives a message from a broadcast sender of the element interface unit and transmits the message to the formatter. Then, the formatter 131e receives a message from the broadcast receiver or from the dispatcher and transforms the format of the received message (input/output message formatting formalized by a CLI command), and the formatter transmits the formatted message to a log sender 131f for the output of an operator screen and to a receiver of a log management module for the storage of a log file.

The log management module 132 receives various messages transmitted through the element interface unit, and the log management module stores and manages the received messages as a log file. To this end, the log management module includes a receiver 132a, a logger 132b, and a finder 132c. The receiver 132a receives the message from the formatter 131e of the user interface module and transmits the received message to the logger. Then, the logger 132b generates, stores, and manages the log file based on the received message. Meanwhile, in a case where information stored in the log file is needed, the finder 132c retrieves the log file.

The system back-end function unit 120 performs detailed functions or operations of the EMS server that manages the network elements. In addition, the system back-end function unit 120 includes a command control module, a configuration management module, a fault management module, a download management module, a diagnostics & test management module, a statistics management module, a performance management module, etc.

First, the command control module 121 reads a batch processing command that the EMS client registers in advance, from the database, and transmits the command to corresponding network elements. Then, the command control module 121 receives a response to the command and provides the response to the EMS client. To this end, the command control module includes a manager processor 121a, a batch processor 121b, and a scheduler 121c. Upon receiving a request for a batch job of an operator from the dispatcher, the manager processor 121a transmits the request to the batch processor. Then, the manager processor transmits an individual command corresponding to the batch job from the batch processor to the dispatcher, receives a response to the command, generated by a corresponding network element, from the dispatcher, and transmits the response to the batch processor so that it can be stored in the database. Also, the manager processor transmits a batch execution termination response to the user interface module when the final command execution is terminated. According to the request for the batch job transmitted either from the manager processor or from the scheduler, the batch processor 121b gets a command pre-registered in the database in turn, and transmits the command to corresponding network elements, thereby performing the job. Meanwhile, the scheduler reads the batch job stored in the database and transmits the batch job to the batch processor at predetermined time. Then, the batch processor transmits a command related to the job to corresponding network elements.

The configuration management module 122 performs various functions including physical topology management, operation parameter setting, setting of adjacent cell/adjacent RAS/adjacent ACR of the network element (e.g. RAS, ACR, etc). Specifically, in relation for the element related request message received from the EMS client, the configuration management module receives a result from processing of the element related request message by a corresponding RAS or ACR in the form of an event message through the element interface unit. The configuration management module transforms the received result into data that can be stored in the database, and stores the transformed data in the database. In a case where an equipment status or an administration state of the network elements is modified, the configuration management module transmits a status modification message to the EMS client through the user interface module. Herein, the physical topology management includes increased/decreased installation of ACR/RAS, increased/decreased installation of frequency assignment/sector/card, etc. Herein, the operation parameter setting includes parameters of a system timer, an OFDMA Physical Layer (PHY) and a Medium Access Control (MAC) layer for uplink/downlink channel, security related Primary Key Management (PKM), a service class for Quality of Service (QoS), a several Radio Frequency (RF), an IP pool, a Dynamic Host Configuration Protocol (DHCP), and an overload threshold, etc.

The fault management module receives fault information transmitted in real-time from the RAS and the ACR (i.e. network elements) and generates viewable and audible information. Specifically, when the fault management module receives a fault occurrence message or a fault release message corresponding to the types of faults (e.g. a specific part of hardware or a specific function of software) from the RAS and the ACR through the element interface unit, the fault management module stores the message in the database and performs an alarm function by broadcasting the fault occurrence message or the fault release message to the EMS client through the user interface module.

The download management module downloads software (OS & application) and a configuration file, used in the RAS and the ACR, (i.e. network elements) into a corresponding network element and performs a function of backing up the configuration file executed in the network element. Specifically, by the operator requirement, at the time of system initialization, or through reservation job registration, the download management module downloads a configuration file and software used according to each network element into a corresponding element, and stores the history information in the database. The software and the configuration file may be registered in a package management module of the EMS client. Also, through the operator requirement or reservation job registration, the download management module backs up software, which is currently being executed in a corresponding network element, or a configuration file, which is stored in the network element, into the EMS server, and then stores history information thereof in the database.

The diagnostics & test management module performs a function which tests system resources of the RAS and the ACR (i.e. network elements) and determines existence or absence of faults. Specifically, through reservation test setting of an operator, the diagnostics & test management module tests resources of the RAS and the ACR at corresponding time, and the diagnostics & test management module reports resource status to an operator through the user interface module upon detecting an insecurity resource. Moreover, in a case where there is a new device or a replaced device, function test of a corresponding device is performed before service provision. In a case where elements have already operated, a service for the resources is interrupted before the start of the diagnosis of a corresponding system.

Meanwhile, each of the configuration management module, the fault management module, the download management module, and the diagnostics & test management module as described above includes a receiver, a data processor, and a command processor (see FIG. 3). The receiver within each of the function modules receives related data from a router of the element interface unit, and transmits the received data to the data processor. Then, the data processor processes the data transmitted from the receiver so as to conform to a function of a corresponding module, and stores resultant data in the database. Also, the command processor within each of the function modules processes a command transmitted from the dispatcher of the user interface module, and performs functions of configuration management, fault management, download management, diagnostics & test management, etc.

The statistics management module performs a function that gathers statistics related data for services and faults of network elements, such as the RAS and the ACR, according to a period (e.g. 60 minutes), and generates statistics data based on a predetermined period (e.g. every day, every week, every month, etc). Specifically, the statistics management module receives performance data and fault data from the RAS and the ACR through the element interface unit, generates performance statistics data (e.g. handover statistics, call processing and traffic statistics, radio channel quality statistics, equipment processor load statistics, etc) and fault statistics data according to a predetermined period, and stores the generated data in the database. When the statistics data exceeds a performance threshold, the statistics management module generates a QoS alarm and transmits the generated QoS alarm to an event handler of a user interface module.

The performance management module gathers and monitors performance related data about the RAS and the ACR, i.e. network elements by periods (e.g. five minutes). Specifically, the performance management module receives a five-minute statistics file containing performance related data from the RAS and the ACR, extracts monitoring item data from the received file, and applies a predetermined threshold to the file, thereby generating performance monitoring data. Moreover, the performance management module stores and manages the performance monitoring data in the database. When the performance monitoring data exceeds the threshold, the performance management module generates a QoS alarm message so as to store its history, and transmits the message to the EMS client through a user interface module. The performance related data may include a processor CPU load rate of the RAS and the ACR, a traffic transmission rate/an error rate, the number of connected PSSs, handover failure rate, etc.

Meanwhile, each of the statistics management module and the performance management module as described above includes a receiver, a data processor, and a DB loader (see FIG. 3). A receiver of each function module receives related data from the router of the element interface unit and transmits the received data to the data processor. Each data processor processes the data so as to conform to a function of a corresponding module and transmits the processed data to the DB loader, and the DB loader stores the data processed by the data processor in the database.

Hereinafter, the element interface unit 140 will be described. As described above, the element interface unit 140 is directly connected with the RAS and the ACR using various communication protocol schemes (e.g. TCP, SNMP, FTP/TFTP, etc.) and the element interface unit 140 gathers and receives data and transmits an operator request and a command. To this end, the element interface unit includes a TCP interface 141, an SNMP interface 142, an FTP/TFTP interface 143, a command receiver 144, a network element handler 145, a network element alive checker 146, a broadcast sender 147, a statistics information collector 148a, a parser 148b, a router 149, etc., so as to communicate with network elements.

First, an interface to communicate with network elements may include a TCP interface, an SNMP interface, an FTP/TFTP interface, etc.

The TCP interface 141 uses TCP so as to communicate with network elements, such as the RAS and the ACR. The EMS server transmits and receives request/response messages for operation, management, maintenance/repair, etc., regarding the network elements through the TCP interface and the EMS server receives fault information and status information. In the present invention, TCP based Inter Processor Communication (IPC) is performed in order to achieve rapid message transmission or in order to prevent loss of a message.

The SNMP interface 142 uses SNMP so as to communicate with network elements, such as the RAS and the ACR. To this end, the EMS server (that is, element interface unit) includes an SNMP manager and a corresponding network element includes an SNMP agent. The SNMP manager transmits ‘Get/Get Next/Get Bulk/Set’ commands to the SNMP agent of the network element, receives a response to the commands, and gathers status and setting information of the element, and receives an event and alarm information from the SNMP agent of the element through ‘Trap’. Also, the SNMP manager gathers and synchronizes a Management Information Base (MIB) of the SNMP agent at the request of the MIB synchronization module (not shown).

The FTP/TFTP interface 143 uses an FTP/TFTP so as to communicate with the network elements, such as the RAS and the ACR. The EMS server uses an FTP/TFTP interface for file transfer with large amount of data, such as software file transfer, configuration information file transfer, and statistics data file transfer. FIG. 3 shows the EMS server including an FTP/TFTP server as a separate sub server for smooth operation.

The command receiver 144 receives an operator command from the user interface module and transmits the command to a corresponding network element. Specifically, when receiving the command from the EMS client, the dispatcher of the user interface module classifies the received command and transmits the classified command either to the command control module of the system back-end function unit or to the command receiver of the element interface unit. As described above, in a case of a complex processing command requiring operation of the system back-end function unit, the dispatcher of the user interface module transmits the complex processing command to the command control module. In a case of a simple processing command requiring no operation of the system back-end function unit, the dispatcher of the user interface module directly transmits the simple processing command to the command receiver. Then, the command receiver transmits the command to a network element through a proper interface of the TCP interface or the SNMP interface, and the command receiver receives a response to the command and transmits the response to the dispatcher of the user interface module. Meanwhile, when an existing communication interface (e.g. TCP interface, SNMP interface) has an error, the command receiver changes the existing communication interface into another interface capable of communication with a network element, and transmits a command through the new interface.

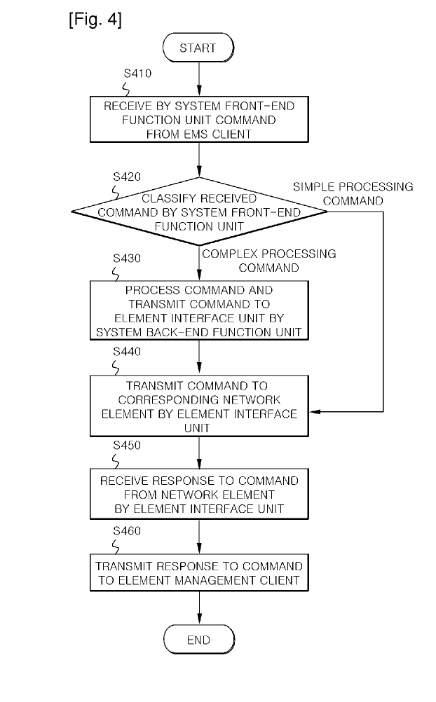

FIG. 4 is a flowchart showing a process by which an EMS server handles a command for element management according to the present invention. For simplified description, the GUI adaptor of the user interface module receives a command from the EMS client and transmits the command to the dispatcher (S410). Then, the dispatcher of the user interface module classifies the received command according to the predetermined basis (S420). The classification basis can be set and modified by an operator. In the present embodiment as described above, a command is broadly divided into two types of a command, which include a complex processing command requiring operation of the system back-end function unit and a simple processing command requiring no operation of the system back-end function unit. However, there is only an illustrative classification, and it is possible to previously set available paths by predetermining the type and the class of a command. In a case where the command corresponds to a simple processing command, the dispatcher of the user interface module transmits the command to the command receiver of the element interface unit. In a case where the command corresponds to a complex processing command, the dispatcher of the user interface module transmits the command to the command control module of the system back-end function unit. Meanwhile, the command control module of the system back-end function unit processes the command received from the dispatcher. The command control module of the system back-end function unit also transmits a command to the command receiver of the element interface unit when some contents of the command must be transmitted to an element (S430). The command receiver of the element interface unit transmits the command transmitted from the user interface module to a corresponding network element (S440). Then, when receiving the response to the command from the network elements, the element interface unit transmits the response to the user interface module. Finally, the user interface module transmits the response to the EMS client, thereby notifying the response to an operator (S450).

Referring again to FIG. 3, the network element handler 145 performs functions of addition/removal management regarding network elements, such as the RAS and the ACR. Specifically, in a case where an RAS or an ACR is added or removed by a command transmitted from the EMS client, the connection of a corresponding RAS or a corresponding ACR with the EMS server based on the TCP or the SNMP may be established or interrupted. Then, data of a corresponding RAS or a corresponding ACR is synchronized with data of the EMS.

The network element alive checker 146 periodically monitors if the RAS or the ACR (i.e. network element) is alive, detects link status of message communication with elements based on the TCP or the SNMP, and notifies a result message to the fault management module. Specifically, the network element alive checker periodically checks element status by using a predetermined keep alive message communication regarding the RAS and the ACR managed by the EMS server. As a result of checking element status, when communication is impossible or communication is restarted, the network element alive checker transmits either a fault occurrence message or a fault release message to the fault management module.

The broadcast sender 147 transmits a message, received from the network element through the TCP interface, to the broadcast receiver of the user interface module so as to transmit the message to each function module.

The statistics information collector 148a reads a statistics file (e.g. five minute statistics file, 60 minute statistics file) received through the FTP/TFTP interface, and transmits the file to the parser 148b by the line. Then, the parser 148b analyzes the file by the detailed statistics item and transmits the resultant data to the router.

The router 149 performs a function for routing a message or data, received from a network element through the TCP interface, the SNMP interface, and the parser, to a corresponding function module of the system back-end function unit. To this end, the element interface unit includes a configuration management router for routing configuration related data to the configuration management module, a fault management router for routing fault related data to the fault management module, a download management router for routing data uploaded from elements to the download management module, a diagnostics & test management router for routing diagnostics & test related data to the diagnostics & test management module, a statistics management router for routing statistics related data to the statistics management module, and a performance monitoring router for performance related data to a performance monitoring module.

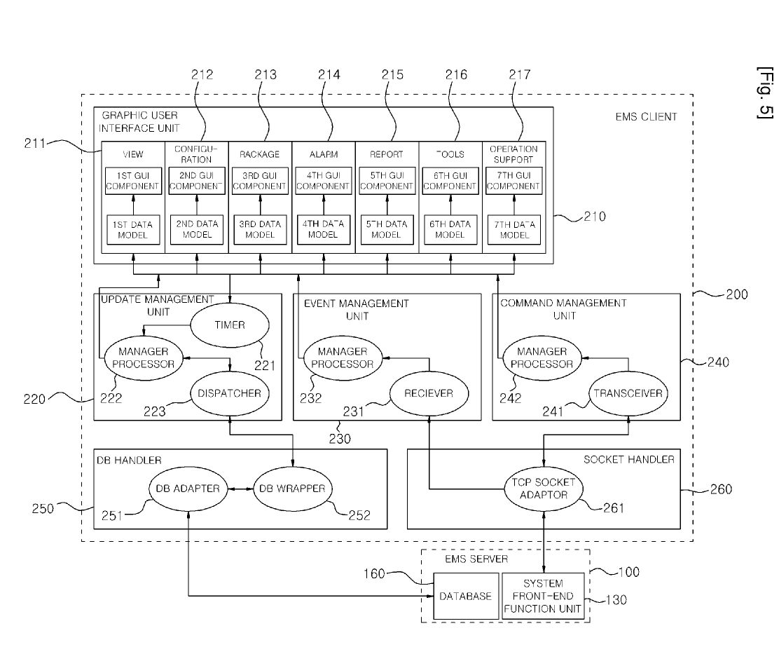

FIG. 5 shows a detailed block diagram of an EMS client according to one embodiment of the present invention. Hereinafter, the EMS client according to the present invention will be described with reference to FIG. 5.

As shown in FIG. 5, the EMS client 200 includes a graphic user interface unit 210, an update management unit 220, an event management unit 230, a command management unit 240, a DB handler 250, and a socket handler 260.

First, the graphic user interface unit 210 performs a function for matching with a user or an operator. The graphic user interface unit includes a data model for managing corresponding data and a GUI component according to each item. Herein, the GUI component performs a function for rendering the data model suitable for a corresponding screen for displaying. Herein, the data model performs a function for storing data of equipment and a system, the data containing configuration information, status information, and history information. As an external function, the graphic user interface unit provides a graphic user interface using the GUI component. As an internal function, the graphic user interface unit implements an interface with the update management unit, the event management unit, and the command management unit using the data model. For reference, FIG. 5 shows the graphic user interface for view 211, configuration 212, package 213, alarm 214, report 215, tools 216, operation support 217, etc.

The update management unit 220 monitors network elements and the update management unit periodically gathers and applies detailed history and status of equipment. To this end, the update management unit includes a timer 221, a manager processor 222, a dispatcher 223, etc. It is preferred that the update management unit is implemented to mainly update only related data model and a GUI activated as a current window, so as to optimize the performance thereof. The data of the updated data model is applied to a corresponding GUI component by event processing.

The event management unit 230 receives fault information and status modification information of the network element in real-time through the EMS server, and the event management unit generates or releases an alarm at the time of the fault occurrence event or the fault release event, thereby generating or releasing viewable and audible alarm. To this end, the event management unit includes a receiver 231 and a manager processor 232. The receiver 231 receives an event, transmitted from the EMS server, through the socket handler 260, and transmits the event to the manager processor 232. Then, the manager processor 232 processes the transmitted event and transmits the processed event to the graphic user interface unit 210.

The command management unit 240 processes an operator command using a queue, and transmits the processed command to the socket handler. Then, the command management unit receives an execution response to the command from the socket handler, and transmits the execution response to the graphic user interface unit. To this end, the command management unit 240 includes a transceiver 241 and a manager processor 242. The manager processor 242 receives an operator command from the graphic user interface unit and processes the received command using the queue, and the manager processor reads an individual command from command queue and transmits the command to the transceiver. The transceiver transmits an operator command to the EMS server through the socket handler and transmits the received response to the command to the manager processor.

The DB handler 250 reads data, such as information, status, and history of network elements, and transmits the data to the update management unit. To this end, the DB handler includes a DB adaptor 251 and a DB wrapper 252. Herein, the DB adaptor 251 acquires information regarding a network element from the database of the EMS server, and adds, removes, or modifies data in the database. The DB wrapper 252 performs a function for wrapping the data acquired from the database according to each management unit.

The socket handler 260 transmits an operator command to the EMS server, receives an alarm event and a response message for the operator command, and transmits the received data or message to a corresponding management unit. In the present invention, the TCP is used to communicate with the EMS server. FIG. 5 shows a structure connected with the EMS server through the TCP socket adaptor 261.

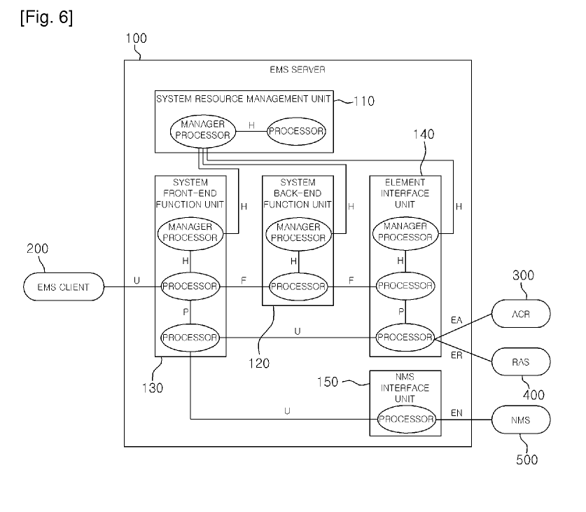

FIG. 6 shows an example of an internal interface of an EMS server as described above. Referring to FIG. 6, a mutual interface is shown based on processors included in the system resource management unit, the system back-end function unit, the system front-end function unit, the element interface unit, and the NMS interface unit of the EMS server. The processors shown in FIG. 6 correspond to the minimum processors necessary for interface distinction. Therefore, the EMS server may include a different number of processors from those in FIG. 6. For example, when each function module includes a processor or processors like the system back-end function unit, processors of an identical level use an identical interface.

Referring to FIG. 6, the internal interface used in the EMS server according to the present invention is classified into four types of interfaces, which are defined as follows.

First, a ‘U’ interface is used as the interface for communication between the EMS server and the EMS client. This is a case where a message transmitted by the EMS client is directly transmitted from the user interface unit to the element interface unit without passing through a system function unit based on the TCP communication.

An ‘F interface’ is used as an interface for communication between the element interface unit and the system back-end function unit, or between the system back-and function unit and the system front-end function unit based on the TCP communication.

Meanwhile, a ‘P’ interface is used as an interface for communication between internal processors within the EMS server. According to the present embodiment, internal processors of the EMS server, that is, processors within each function module of the system back-end function unit, can perform message queue communication using a shadow memory. Therefore, data to be mutually processed is shared and thus rapid data call is achievable.

Finally, an ‘H’ interface is used as an interface between a manager processor and a sub processor within the EMS server based on the User Datagram Protocol (UDP) communication.

For reference, the EMS server is implemented based on a server-client architecture, and the client is developed based on Java and thus the client has no dependency on a specific Operating System (OS). Moreover, it is preferred that the Model-View-Control (MVC) architecture is fully implemented with a Multi-Tier Model: Client Tier/ Business Logic Tier/ Database Tier so as to rapidly and flexibly cope with a request for system expansion, system dispersion arrangement, or modification of system functions. For example, each of the function modules of the system back-end function unit of the EMS server may be implemented in the form of a physically separated sub server either by individually or by grouping the modules.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A system for managing elements of a wireless communication network, the system comprising:
an EMS client including a graphic user interface unit for matching with an operator, a command management unit for receiving a command from the graphic user interface unit and transmitting the received command to a socket handler, and the socket handler for transmitting the command transmitted from the command management unit to an EMS server; and
the EMS server including a system front-end function unit for matching with the EMS client, an element interface unit for matching with elements of the wireless communication network, and a system back-end function unit for processing the command transmitted from the system front-end function unit and performing at least one of a configuration management function, a fault management function, a download management function, a diagnostics & test management function, a statistics management function, and a performance management function regarding elements of the wireless communication network.

2. The system as claimed in claim 1, wherein the system front-end function unit of the EMS server classifies the command transmitted from the EMS client, and transmits the command to the element interface unit when the classified command corresponds to a simple processing command, and transmits the command to the system back-end function unit when the classified command corresponds to a complex processing command.

3. The system as claimed in claim 1, wherein the element interface unit comprises a command receiver for receiving a command from the system front-end function unit and transmitting the command to a corresponding element of the wireless communication network.

4. The system as claimed in claim 1, wherein the EMS server further comprises a Network Management System (NMS) interface unit for matching with an NMS.

5. The system as claimed in claim 1, wherein the element interface unit comprises at least one of a TCP interface, an SNMP interface, and an FTP/TFTP interface.

6. An EMS server of a wireless communication network, the EMS server comprising:
a system front-end function unit for matching with an EMS client, the system front-end function unit having a GUI adaptor connected with the EMS client;
a system back-end function unit for responding to a command received from the EMS client, and performing at least one of a configuration management function, a fault management function, a download management function, and a diagnostics & test management function regarding elements; and
an element interface unit for transmitting a command to the elements of the wireless communication network, and receiving a massage and data necessary for execution of the functions from the elements.

7. The EMS server as claimed in claim 6, further comprising an NMS interface unit for matching with the NMS, and the NMS interface unit include an EMS agent interworking with an EMS manager of the NMS in the wireless communication network.

8. The EMS server as claimed in claim 7, wherein the NMS interface unit comprises an Operation Support System (OSS) interface interworking with an OSS, and the OSS interface is constructed to be separable from the NMS interface unit.

9. The EMS server as claimed in claim 6, wherein the system front-end function unit comprises a log management module for receiving a message transmitted through the element interface unit, and storing and managing the received message as a log file.

10. The EMS server as claimed in claim 6, wherein the system front-end function unit comprises a user interface module for classifying a command transmitted from the EMS client and transmitting the classified command to the system back-end function unit or to the element interface unit.

11. The EMS server as claimed in claim 10, wherein the user interface module comprises at least one of an event handler for transmitting an event transmitted from the system back-end function unit to the EMS client, and a formatter for transforming the format of the message received from the element interface unit to transmit the transformed message to the EMS client.

12. The EMS server as claimed in claim 10, wherein the user interface module comprises a dispatcher for transmitting a command to the element interface unit when the command transmitted from the EMS client corresponds to a simple processing command, and transmitting a command to the system back-end function unit when the command transmitted from the EMS client corresponds to a complex processing command.

13. The EMS server as claimed in claim 6, wherein the system back-end function unit comprises a command control module for receiving and processing the complex processing command from the user interface module.

14. The EMS server as claimed in claim 13, wherein the command control module comprises a batch processor for reading a command pre-registered in a database in turn at the request of the batch job.

15. The EMS server as claimed in claim 13, wherein the command control module comprises a manager processor for transmitting and receiving a command related to the dispatcher.

16. The EMS server as claimed in claims 6, wherein the system back-end function unit comprises at least one of:
a configuration management module for performing a configuration management function of the elements;
a fault management module for performing a fault management function of the elements;
a download management module for performing a download management function of the elements; and
a diagnostics & test management module for performing a diagnostics & test management function of the elements.

17. The EMS server as claimed in claim 16, wherein the download management module manages software and a configuration file used in the elements of the wireless communication network directly connected with the element interface unit, and directly downloads the software and the configuration file into the elements of the wireless communication network.

18. The EMS server as claimed in claim 16, wherein each of the modules comprises a data processor for processing data received from the element interface unit, and a command processor for processing a command received from the dispatcher of the user interface module.

19. The EMS server as claimed in claim 16, wherein the modules perform message queue communication using a shadow memory.

20. The EMS server as claimed in claim 6, where the system back-end function unit comprises at least one of:
a statistics management module for performing a statistics management function of the elements; and
a performance management module for performing a performance management function of the elements.

21. The EMS server as claimed in claim 20, wherein each of the modules comprises a data processor for processing data received from the element interface unit and transmitting the processed data to a DB loader, and the DB loader for storing data transmitted from the data processor in a database.

22. The EMS server as claimed in claim 6, wherein the element interface unit comprises a TCP interface for supporting TCP communication, an SNMP interface for supporting SNMP communication, and an FTP/TFTP interface for supporting FTP/TFTP communication.

23. The EMS server as claimed in claim 6, wherein the element interface unit comprises a command receiver for transmitting and receiving the command, and the command receiver supports at least one of TCP communication, SNMP communication, and FTP/TFTP communication.

24. The EMS server as claimed in claim 6, wherein the element interface unit comprises at least one of:
a network element handler for managing addition or removal of the elements of the wireless communication network;
a network element alive checker for checking if the elements of the wireless communication network are alive; and
a broadcast sender for transmitting a message received from the elements of the wireless communication network to the system front-end function unit.

25. The EMS server as claimed in claim 6, wherein the elements of the wireless communication network comprise an RAS and an ACR, and the RAS and the ACR are directly connected with the element interface unit.
